(19) United States
(12) Patent Application Publication
(10) Pub. No.: US 2009/0155400 A1
(43) Pub. Date: Jun. 18, 2009

(54) Apparatus for Blow Molding

(76) Inventors: Paul Alan Miller, Cement City, MI (US); Gregory Allen Gordon, Blissfield, MI (US)

Correspondence Address: MILACRON INC., 2090 FLORENCE AVE., CINCINNATI, OH, 45206, US

(21) Appl. No.: 11/957,858

(22) Filed: Dec. 17, 2007

(51) Int. Cl. B29C 49/28

(52) U.S. Cl. 425/183; 425/186

(57) ABSTRACT

An apparatus for blow molding comprises a mold component comprising at least one shell member having a semi-cylindrical recess for receiving a cavity sub-assembly having molding surfaces, the cavity sub-assembly being installed in the recess by sliding rotation to a seating position exposing the molding surfaces, and releasable retaining means for restraining the cavity sub-assembly at the seating position whereby the cavity sub-assembly is retained in the recess, the cavity sub-assembly, shell member and retaining means being effective to the cavity sub-assembly to be installed in and removed from the shell member is retained in the clamp unit of a blow molding machine and the retaining means being adapted to restrain and release the cavity sub-assembly without use of tools. The retaining means comprising at least one pin member for engaging the cavity sub-assembly and shell member to restrain the cavity sub-assembly from sliding rotation at the seating position.

### BACKGROUND OF THE INVENTION

1. Field of the Invention

This invention relates generally to blow molding. In particular, this invention relates to mold assemblies for blow molding.

2. Description of Related Art

Blow molding is a cyclic process wherein a parison of material in a moldable condition is centered on the parting plane of a mold assembly, the mold assembly is closed around the parison, the parison is expanded so the exterior of the parison abuts molding surfaces defined by the closed mold assembly, the blow molded article is conditioned to be sufficiently rigid to retain its size and shape while unsupported, the mold assembly is opened and the blow molded article is removed. In general, the moldable condition of the parison is achieved when the material of the parison is at an elevated temperature, and the rigid condition of the blow molded article is achieved when the temperature of the material has been reduced. A blow molding machine comprises a press for opening and closing the mold assembly and blowing means for introducing a pressurized fluid (typically air) to expand the parison in the mold assembly. Alternative types of blow molding equipment are known for production of blow molded containers: so called “two-stage” blow molding equipment expands preformed parisons comprising a single opening and produced by injection molding performed away from the blow molding press; and, so called “single stage” blow molding expands tubular parisons extruded proximate the blow molding press, one open end of the parison being closed by closure of the mold assembly. Two stage blow molding machines typically include means for mechanically stretching the parison longitudinally during blow molding. Additionally, blow molding machines may comprise means for handling the molded article upon removal from the mold assembly, means for trimming waste from the molded article (single-stage machines only), and heat transfer devices to elevate the temperature of the parison to achieve the moldable condition and to reduce the temperature of the blow molded article to achieve the rigid condition.

It is known to use mold assemblies for blow molding wherein each mating mold component comprises a shell member and a cavity sub-assembly comprising at least one cavity member having molding surfaces thereon. It is known to provide shell members and cavity sub-assemblies configured to permit installation and removal of a cavity sub-assembly from the shell member while the shell member is mounted in a clamp unit of a blow molding machine. In known arrangements, a cavity member sub-assembly is retained in a shell member by retaining elements that require use of tools to clamp the cavity sub-assembly to the shell member and to release the cavity sub-assembly from the shell member. Furthermore, in such known arrangements the retaining elements may comprise removable fasteners that must be removed to permit installation and removal of the cavity sub-assembly. The use of such retaining elements increases the time required to replace cavity members required for production of a particular article and, where removable relatively small fasteners are used, increases the potential for loss of such fasteners. Hence, there remains a need to provide apparatus permitting installation and removal of cavity sub-assemblies in mating mold components by means free of the use of tools and removable relatively small fasteners.

### SUMMARY OF THE INVENTION

It is an object of the present invention to provide an apparatus for blow molding wherein a mold component comprises a substantially semi-cylindrical recess for receiving a cavity sub-assembly having molding surfaces, the cavity sub-assembly being installed into the recess by sliding rotation to a seating position exposing the molding surfaces, and the cavity sub-assembly is restrained at the seating position by releasable retaining means whereby the cavity sub-assembly is retained in the shell member, the retaining means being released from the cavity sub-assembly to permit the cavity sub-assembly to be installed in and removed from the recess while the mold component is retained in a clamp unit of a blow molding machine and being adapted to retain and release the cavity sub-assembly without use of tools.

It is a further object of the present invention to provide such an apparatus for blow molding wherein the retaining means comprises at least one pin member for engaging the cavity sub-assembly and the shell member to restrain the cavity sub-assembly at the seating position, the pin members being disengaged from at least the cavity sub-assembly to permit the cavity sub-assembly to be installed in and removed from the recess.

Further objects and advantages of the invention shall be made apparent from the accompanying drawings and the following description thereof.

In accordance with the aforesaid objects the present invention provides an apparatus for blow molding comprising first and second mating mold components, each mating mold component comprising a mold shell member having a recess open to a mating face of the mold component for receiving a cavity sub-assembly comprising at least one mold cavity member having molding surfaces and at least one support surface for support by the recess, the recess being substantially semi-cylindrical and the support surfaces conforming to the recess so as to allow the cavity sub-assembly to be installed in the recess and removed from the recess by sliding rotation of the cavity sub-assembly relative to the shell member, the cavity sub-assembly being installed in the recess to a seating position exposing the molding surfaces, and releasable retaining means for restraining the cavity sub-assembly at the seating position whereby the cavity sub-assembly is retained in the shell member, the cavity sub-assembly, shell member and retaining means being effective to permit a cavity sub-assembly to be installed in and removed from a shell member while the shell member is retained in a clamp unit of a blow molding machine and the retaining means being adapted to restrain and release the cavity sub-assembly without use of tools.

### BRIEF DESCRIPTION OF THE DRAWINGS

FIGS. 1a and 1b illustrate a preformed parison and finished container, respectively, of a two-stage blow molding process.

FIG. 2 is a three dimensional view of a mold assembly comprising mold shell members and cavity sub-assemblies used for blow molding containers.

FIGS. 3a, 3b and 3c are three dimensional views of a mold component according to the invention.

FIGS. 4a, 4b and 4c are three dimensional views of shell members of FIGS. 3a and 3b.

FIGS. 5a, 5b and 5c are three dimensional views of cavity sub-assemblies of FIGS. 3a and 3b.

FIG. 6 is a partial sectional view of an assembly of the mold members of FIGS. 4a and 5a.

FIG. 7 is a partial sectional view of an assembly of the mold members of FIGS. 4b and 5b.

### DETAILED DESCRIPTION OF THE PREFERRED EMBODIMENT

The invention shall be illustrated with reference to a preferred embodiment which shall be described in detail. It is not the intention of applicants that the invention be limited to the preferred embodiment, but rather that the invention shall be defined by the appended claims and all equivalents thereof.

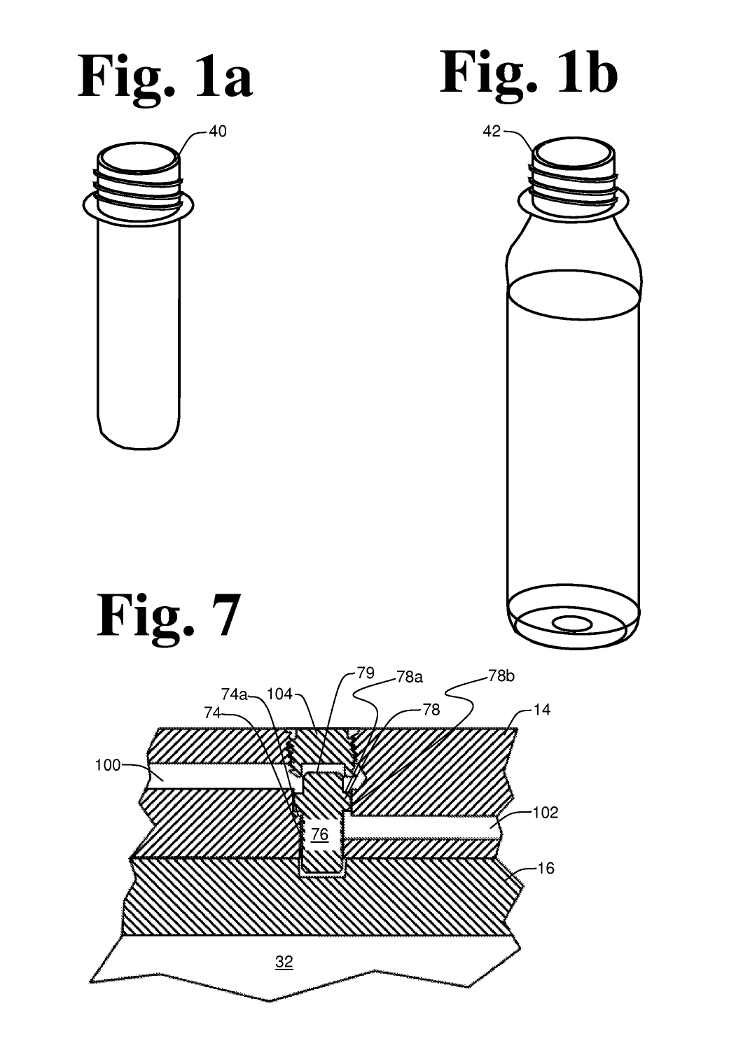

While the invention is suitable for use with single-stage blow molding, the preferred embodiment will be described with reference to a two-stage blow molding process. A two-stage blow molding process expands a preformed parison such as parison 40 illustrated in FIG. 1a, typically including a completed neck finish, to produce a finished container such as container 42 illustrated in FIG. 1b. Preformed parison 40 is typically produced by injection molding. In preparation for blow molding, the material of preformed parison 40 is conditioned (heated) to be made deformable. A mold assembly is closed around the conditioned, preformed parison and blow molding commences with closure of the mold assembly. During blow molding, pressurization of preformed parison 40 is advantageously accompanied by mechanical stretching along the length of preformed parison 40 to produce container 42. The wall thickness, diameter and length of parison 40 are chosen in accordance with properties of the material from which it is produced and the extent of expansion to be effected both axially and radially during blow molding. Following expansion, the material of container 42 is conditioned (cooled) to become sufficiently rigid for removal from the mold assembly.

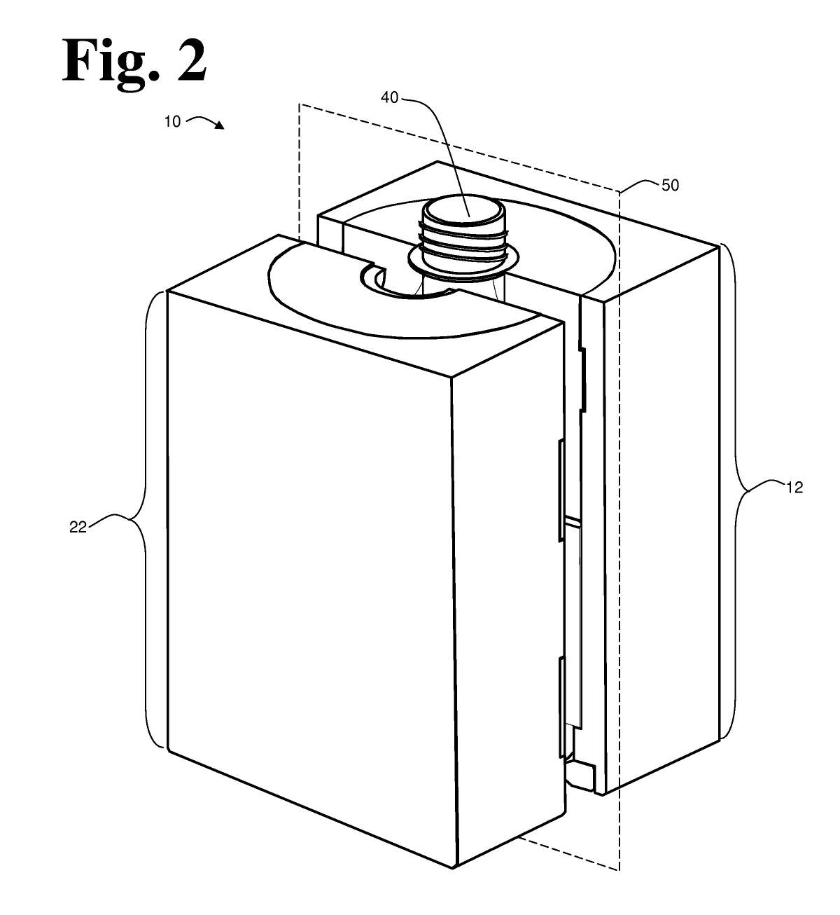

Referring to FIG. 2, mold assembly 10 comprises mating mold components 12 and 22 each referred to herein as a “mold half”. Each of mold components 12 and 22 is carried by a member of a molding machine press, so called “clamp unit” (not shown) for translating the mold components between open and closed positions relative to each other (the relative position depicted in FIG. 2 is between the fully open and fully closed positions). In the open position, mold components 12 and 22 are separated permitting admission of a parison such as parison 40 there between and removal of a molded article upon completion of a molding operation. In the closed position, mating faces of mold components 12 and 22 abut at parting plane 50, the abutting faces of mold components 12 and 22 having molding surfaces thereon defining a cavity. With the molds closed surrounding the parison, the parison is pressurized to expand the parison material to abut the molding surfaces of the cavity, and in some instances, mechanically stretched longitudinally by introduction of a stretch rod or the like through the parison mouth as is known. Containers produced using mold assembly 10 advantageously comprise neck portions having surface features formed thereon such as the threads shown in FIG. 2 for engaging a container closure.

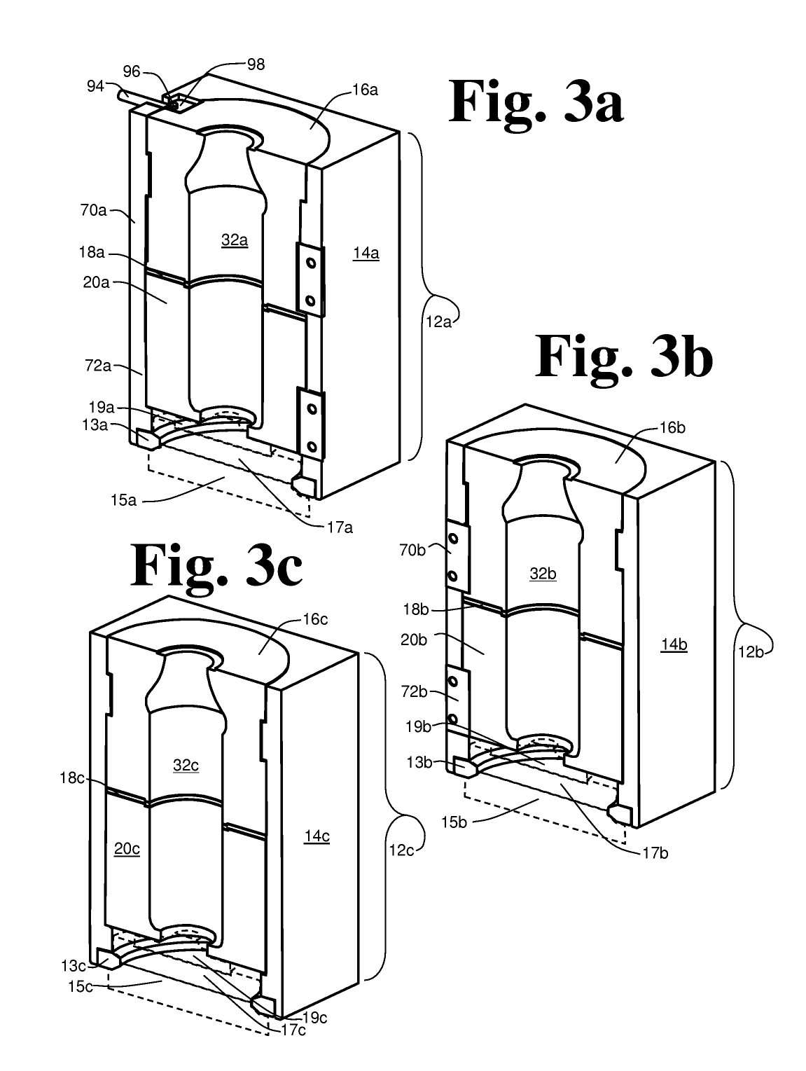

Referring to FIG. 3a, mold component 12 comprises shell member 14a supporting cavity members 16a and 20a and height insert 18a, all of cavity members 16a and 20a and height insert 18a comprising molding surfaces 32a of the cavity defining the body of the container to be blow molded. A mold base 19a (shown in phantom (dashed line) in FIG. 3a) comprises molding surfaces defining at least a portion of the closed end of the container and is mounted to mold insert 20a by base support 17a and support retainer 15a (both shown in phantom (dashed line) in FIG. 3a). Advantageously, concavity of the closed end of container 42 is provided by the molding surfaces of mold base 19a. Base support 17a and support retainer 15a are fastened together by bolts or the like (not shown). The periphery of the thus assembled base support 17a and support retainer 15a engage the projection of locating ridge plate 13a. Mold inserts 16a and 20a together with height insert 18a establish the longitudinal extent of the body of the container to be produced. With height insert 18a omitted, mold inserts 16a and 20a establish the longitudinal extent of the body of the container to be produced.

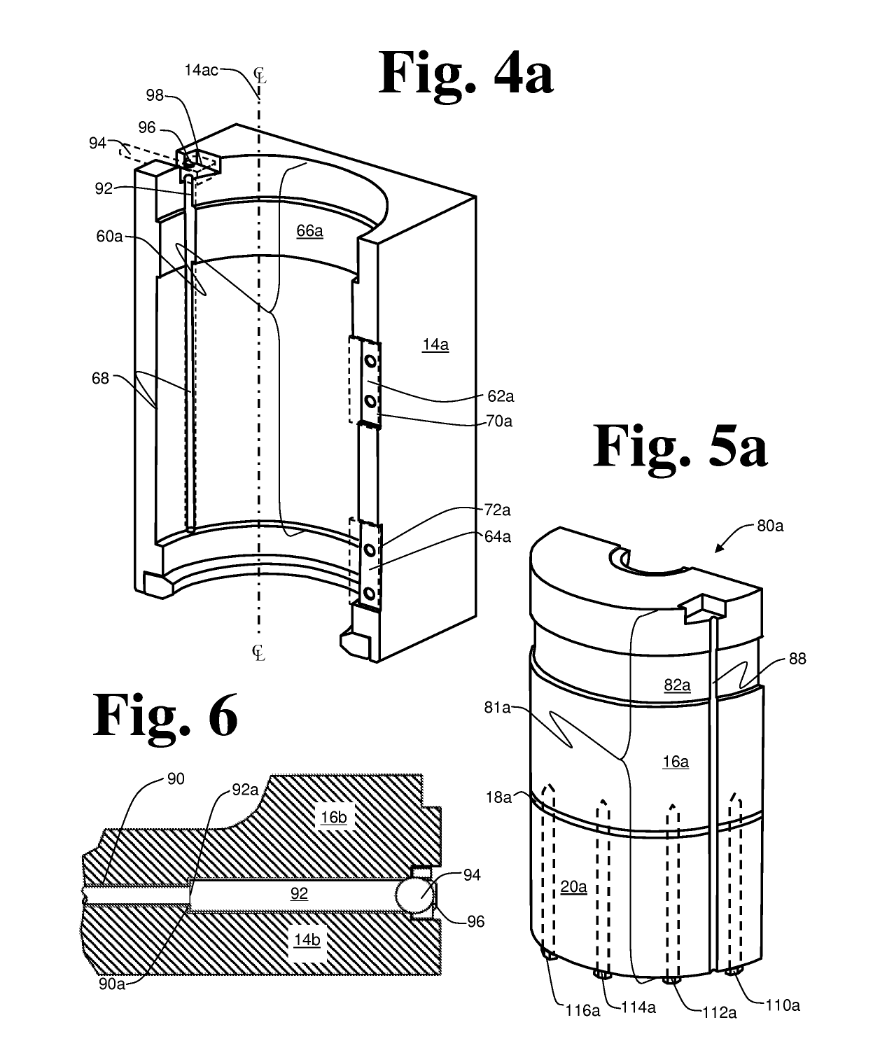

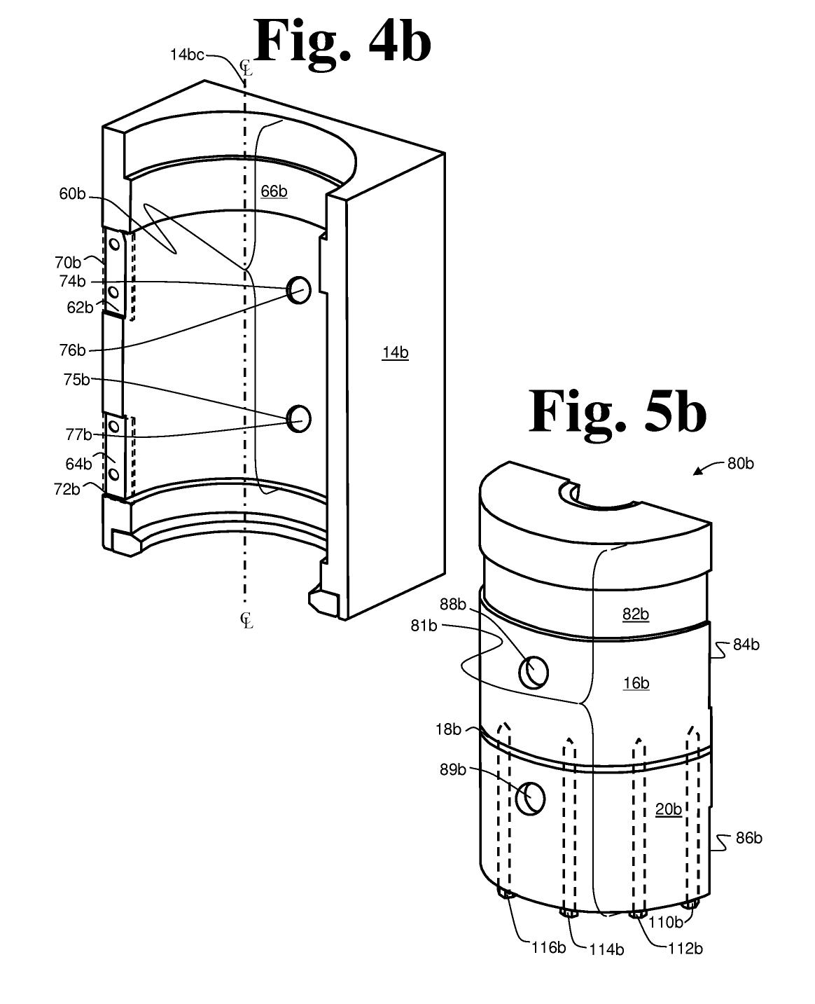

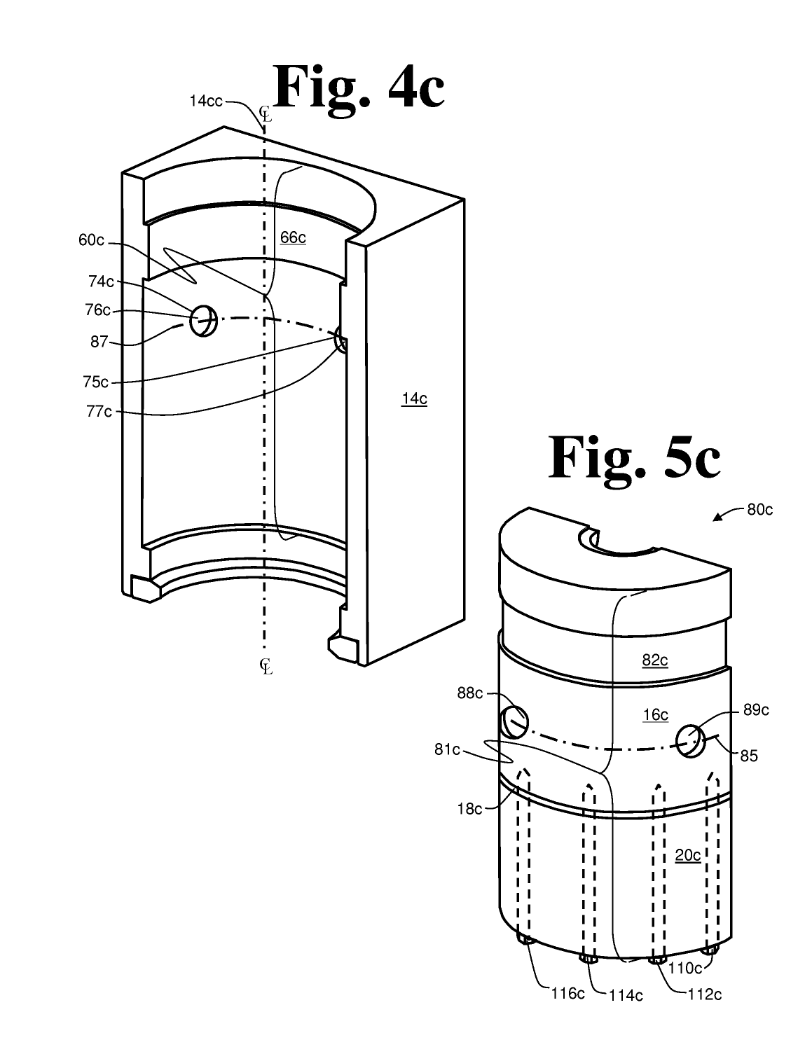

Referring to FIGS. 3a, 4a, 5a and 6 insert recess 60a of shell member 14a is substantially semi-cylindrical and open to the mating face side of shell member 14a. Stop recesses 62a and 64a receive stop plates 70a and 72a (shown in phantom (dashed) as being removed in FIG. 4a) which project beyond the surface of insert recess 60a toward the centerline 14ac of shell member 14a. Cavity members 16a and 20a are joined by fasteners such as fasteners 110a-116a (shown in phantom (dashed)) so as to clamp height insert 18a. Cavity members 16a, 20a and height insert 18a comprise cavity sub-assembly 80a suitable for installation in shell member 14a. As used herein, “cavity sub-assembly” and “cavity sub-assemblies” refer to the member or assembly of members comprising molding surfaces and to be received in the recess of a shell member. Shell member 14a advantageously comprises locating ridge 66a comprising recess 60a and cavity member 16a comprises mating locating recess 82a comprising support surface 81a. Locating ridge 66a and locating recess 82a are effective to locate cavity sub-assembly 80a axially within recess 60a. Installation of cavity sub-assembly 80a into shell member 14a is effected by sliding rotation of support surface 81a relative to the exposed surface of recess 60a from the side of insert recess 60a opposite stop plates 70a and 72a to bring stop surfaces (not shown) of cavity members 16a and 20a into abutment with stops such as stop plates 70a and 72a, respectively, placing cavity sub-assembly 80a at a seating position in insert recess 60a, as illustrated in FIG. 3a. Although stop plates 70a and 72a are illustrated as separable elements attached to shell member 14a, stops could be any projection proximate the face of shell member 14a protruding beyond the surface of the recess 60a towards centerline 14ac to engage stop surfaces of cavity sub-assembly 80a.

A first arrangement of releasable retaining means for restraining a cavity sub-assembly at a seating position shall be described with reference to FIGS. 3a, 4a, 5a and 6. The releasable retaining means restraining a cavity subassembly such as cavity sub-assembly 80a for retention with shell member 14a. The cavity sub-assembly being released to permit installation in and removal from recess 60a. Releasable retaining means in accordance with the invention are adapted to restrain and release a cavity sub-assembly without use of tools. To this end, a pin member, such as pin member 92 is installed to engage cavity sub-assembly 80a and shell member 14a, pin member 92 being removed to release cavity sub-assembly 80a. A pin receiving hole 90 is created by alignment of longitudinal groove 68 in insert recess 60a with longitudinal groove 88 in support surface 81a of cavity sub-assembly 80a, such alignment being achieved when cavity sub-assembly 80a is located at the seating position shown in FIG. 3a. With cavity sub-assembly 80a seated in recess 60a, pin member 92 (shown in phantom (dashed) in FIG. 4a) is inserted in pin receiving hole 90 substantially filling pin receiving hole 90 and restraining cavity sub-assembly 80a at the seating position in insert recess 60a. Cavity sub-assembly 80a is thereby retained in shell member 14b by virtue of such restraint and abutment of stop surfaces of cavity sub-assembly 80a with stop plates 70a and 72a, respectively.

Continuing with reference to FIGS. 3a, 4a, 5a and 6, a handle 94 is attached at head 96 of pin member 92 (all shown in phantom (dashed) in FIG. 4a), by for example, threaded engagement therewith (threads not shown). Handle 94 facilitates manipulation of pin member 92 for insertion into and removal from pin receiving hole 90. Pin member 92 is advantageously cylindrical and advantageously includes at least one longitudinal portion of reduced diameter defining at least one shoulder such as shoulder 92a along the length thereof. The longitudinal portions of reduced diameter and shoulders defining stepped diameters of pin member 92. Pin receiving hole 90 includes corresponding longitudinal portions of reduced diameter defining corresponding shoulders such as shoulder 90a along the length thereof defining stepped diameters of pin receiving hole 90. Pin member 92 is inserted into pin receiving hole 90 so that respective shoulders of each abut, seating pin member 92 in pin receiving hole 90. As installed in a machine clamp unit, mold assembly 10 is upright so that the shell members of mating mold components 12 and 22 are upright (as shown in FIG. 2) and pin members such as pin member 92 are held in place by gravity. To restrain pin member 92 from lateral movement when no cavity sub-assembly is installed in a shell member such as shell member 14a, a head block 98 (shown in phantom (dashed) in FIG. 4a) holds pin member 92 in abutment with longitudinal groove 68.

A first alternative arrangement of pin members comprising a releasable retaining means is illustrated by FIGS. 3b, 4b, 5b and 7. Shell member 14b corresponds substantially to shell member 14a and allows installation of cavity sub-assembly 80b by sliding rotation into insert recess 60b in the same manner of installation of cavity sub-assembly 80a into shell member 14a. In FIG. 7, the partial cross section 14 represents a partial cross section of a shell member such as shell member 14b, partial cross section 16 represents a partial cross section of a cavity member of a cavity sub-assembly such as cavity member 16b, molding surfaces such as molding surfaces 32b are represented by surface 32 and pocket 74 represents a pocket such as pocket 74b for receiving a pin member. In addition, in FIG. 7, pin member 76 represents a pin member such as pin member 76b. Stop recesses 62b and 64b receive stop plates 70b and 72b (shown in phantom (dashed) as being removed in FIG. 4b) which project beyond the surface of insert recess 60b toward the centerline 14bc of shell member 14b. Although stop plates 70b and 72b are illustrated as separable elements attached to shell member 14b, stops could be any projection proximate the face of shell member 14b and protruding beyond the surface of recess 60b towards centerline 14bc to engage stop surfaces 84b and 86b. Cavity members 16b, 20b and height insert 18b comprise cavity sub-assembly 80b. Cavity members 16b and 20b are joined by fasteners such as fasteners 110b-116b (shown in phantom (dashed)) so as to clamp height insert 18b. Support surface 81b of cavity sub-assembly 80b comprises locating recess 82b for mating with locating ridge 66b of shell member 14b to locate cavity sub-assembly 80b axially in recess 60b. At least one pocket, such as pocket 74b in insert recess 60b receives a pin member such as pin member 76b (pockets 74b and 75b are shown with pin members 76b and 77b recessed therein, respectively). To engage cavity sub-assembly 80b, pin members 76b and 77b are positioned within pockets 74b and 75b so that a portion of each pin member projects beyond the surface of insert recess 60b and is received in a pin recess (as illustrated in FIG. 7), such as pin recesses 88b and 89b in support surface 81b of cavity sub-assembly 80b. As so positioned, pin members 76b and 77b remain engaged with shell member 14b at pockets 74b and 75b, respectively. When so engaged, cavity sub-assembly 80b is restrained at the seating position in recess 60b, as illustrated in FIG. 3b, and is effectively retained in shell member 14b by virtue of such restraint and abutment of stop plates 70b and 72b with stop surfaces 84b and 86b, respectively.

A second alternative arrangement of pin members comprising a releasable retaining means is illustrated by FIGS. 3c, 4c, 5c and 7. Shell member 14c corresponds substantially to shell member 14b and allows installation of cavity sub-assembly 80c by sliding rotation into insert recess 60c in the same manner of installation of cavity sub-assembly 80b into shell member 14b. In FIG. 7, the partial cross section 14 represents a partial cross section of a shell member such as shell member 14c, partial cross section 16 represents a partial cross section of a cavity member of a cavity sub-assembly, such as cavity member 16c, partial cross section 16 represents a partial cross section of a cavity member of a cavity sub-assembly such as cavity member 16b, molding surfaces such as molding surfaces 32c are represented by surface 32 and pocket 74 represents a pocket such as pocket 74b for receiving a pin member. In addition, in FIG. 7, pin member 76 represents a pin member such as pin member 76c. Unlike shell member 14b, shell member 14c comprises no stops to establish a seating position of cavity sub-assembly 80c in recess 60c. Cavity members 16c, 20c and height insert 18c comprise cavity sub-assembly 80c. Cavity members 16c and 20c are joined by fasteners such as fasteners 110c-116c (shown in phantom (dashed)) so as to clamp height insert 18c. Support surface 81c of cavity sub-assembly 80c comprises locating recess 82c for mating with locating ridge 66c of shell member 14c to locate cavity sub-assembly 80c axially in recess 60c.

Continuing with reference to FIGS. 3c, 4c, 5c, and 7, a seating position of cavity sub-assembly illustrated in FIG. 3c is established by engagement of at least two pin members with shell member 14c and cavity sub-assembly 80c. Installation of cavity sub-assembly 80c into shell member 14c is effected by sliding rotation beginning from either side of the face of shell member 14c. Cavity sub-assembly 80c is positioned to expose molding surfaces 32c with the face of cavity sub-assembly 80c substantially parallel to the face of shell member 14c. At least two pockets, such as pockets 74c and 75c in insert recess 60c each receive a pin member such as pin members 76c and 77c (pockets 74c and 75c are shown with pin members 76c and 77c recessed therein, respectively). To engage cavity sub-assembly 80c, pin members 76c and 77c are positioned within pockets 74c and 75c so that a portion of each pin member projects beyond the surface of insert recess 60c and is received in a pin recess (as illustrated in FIG. 7), such as pin recesses 88c and 89c in support surface 81c of cavity sub-assembly 80c. Pin members 76c and 77c are arranged on shell member 14c so that when extended to engage pin recesses 88c and 89c while remaining engaged with pockets 74c and 75c, respectively, cavity sub-assembly 80c is restrained from sliding rotation. The direction of travel of pin members 76c and 77c within pockets 74c and 75c, respectively, is chosen so that engagement of shell member 14c and cavity sub-assembly 80c by two pin members is effective to restrain cavity sub-assembly from sliding rotation. As illustrated in FIGS. 4c and 5c, pin members 76c and 77c are arranged so that the respective directions of travel within pockets 74c and 75c are aligned radially with respect to centerline 14cc. With such directions of travel, when pin members 76c and 77c are advanced to engage cavity sub-assembly 80c, while remaining engaged with shell member 14c, cavity sub-assembly 80c is restrained from sliding rotation at the seating position in recess 60c, as illustrated in FIG. 3c, and is effectively retained in shell member 14c by virtue of such restraint. As illustrated in FIGS. 4c and 5c, pin members 76c and 77c are arranged on a circumference of recess 60c such as the circumference 87. It is not necessary that the pin members be arranged on the same circumference, it is only necessary that the directions of travel of at least two pin members be oriented so that engagement of those pin members with the cavity sub-assembly and the shell member is effective to restrain sliding rotation of the cavity sub-assembly. To accommodate cavity sub-assemblies comprising replaceable height inserts such as height insert 18c, selected to determine overall length of molding surfaces 32, the arrangement of pin members such as pin members 76c and 77c is chosen to permit engagement of a cavity member such as cavity member 16c the location of which, as cavity sub-assembly 80c is installed in recess 60c, is not altered by the particular height insert 18c selected. As illustrated in FIGS. 4c and 5c, pin members are arranged on circumference 87 which, with cavity sub-assembly at the seating position, is aligned with circumference 85 of cavity member 16c.

Operation of pin members of the first alternative arrangement of FIGS. 3b, 4b and 5b and of the second alternative arrangement of FIGS. 3c, 4c and 5c shall be described with reference to FIG. 7. The depth of a pin member 76 within a pin pocket 74 is established by depth establishing means applying forces to the pin member, such as effected by hydraulic or pneumatic means. Each pin member 76 comprises a piston such as piston 78. Each pocket 74 is in fluid communication with passages such as passages 100 and 102 for supplying pressurized fluid (gas or liquid). Piston 78 is effective to segregate pressurized fluid in passage 100 from pressurized fluid in passage 102. Advantageously, a plug 104 closes pocket 74 at the outside of shell member 14 and is of adjustable depth within pocket 74. Depth of pin member 76 in pocket 74 is established by pressurized fluid acting on opposed piston surfaces 78a and 78b of piston 78 and pin end 79. Pressurized fluid in passage 100 contacts pin end 79 and first piston surface 78a; pressurized fluid in passage 102 contacts second piston surface 78b. With greater force resulting from pressurized fluid contacting second piston surface 78b than resulting from pressurized fluid contacting first piston surface 78a and pin end 79, pin end 79 is driven into abutment with adjustable plug 104 so that pin member 76 is at its deepest location within pocket 74 and no portion thereof projects beyond the surface of the recess of shell member 14. With greater force resulting from pressurized fluid contacting first piston surface 78a and pin end 79 than resulting from pressurized fluid contacting second piston surface 78b, second piston surface 78b is driven into abutment with shoulder 74a of pocket 74 so that pin member 76 is at its shallowest location within pocket 74 and a portion of pin member 76 projects beyond the surface of the recess in shell member 14 while pin member 76 remains engaged with shell member 14. An imbalance of forces effective to drive pin member 76 may be achieved by altering the relative fluid pressure in passages 100 and 102 in conventional manner using valves (not shown) for connecting passages 100 and 102 to fluid sources and returns.

Although illustrated as comprising height inserts such as height inserts 18a and 18b, it is to be understood that cavity sub-assemblies may lack such inserts entirely, may comprise panel inserts comprising molding surfaces defining portions of the sidewalls of articles being molded, or may comprise unitary members comprising all molding surfaces such as are illustrated rather than comprising cavity members comprising only portions of such molding surfaces. Further, in mold components used in extrusion blow molding processes where features of an article neck intended to engage a separable closure are formed with closure of a mold assembly upon a tubular extrusion, each cavity sub-assembly may comprise members having molding surfaces defining such neck features. While the pin members are illustrated as substantially cylindrical members and while the pin recesses are illustrated as substantially cylindrical recesses, it is not intended to limit the invention to pins of cylindrical shapes. Rather, pin members may include non-cylindrical portions for engaging at least one of a cavity sub-assembly and a shell member. The shape and size of the portions of pin members for engaging cavity members may advantageously, for example, have cross-sections suited to spanning the boundaries of two or more cavity members of a cavity sub-assembly.

The invention is effective to eliminate use of fasteners such as bolts and the like requiring use of tools to secure cavity sub-assemblies in shell members of mold assemblies. By virtue of handle 94 and stepped diameters of pin member 92 and pin receiving hole 90, pin members illustrated in FIGS. 3a, 4a, 5a and 6 may be inserted into and removed from mold components without use of any tools whatsoever. Likewise, by virtue of use of pressurized fluid to operate pin members such as pin members 76 and 77 illustrated in FIGS. 3b, 4b, 5b and 7, such pin members can be disengaged from cavity sub-assemblies without use of any tools whatsoever. The elimination of fasteners and need for tools to remove and install cavity sub-assemblies into shell members reduces time required to replace cavity subassemblies, reducing costs of tooling changeover and increasing time that a blow molding machine so equipped is available for production.

What is claimed is:

1. An apparatus for blow molding comprising first and second mating mold components, each mating mold component comprising a mold shell member having a recess open to a mating face of the mold component for receiving a cavity sub-assembly comprising at least one mold cavity member having molding surfaces and at least one support surface for support by the recess, the recess being substantially semi-cylindrical and the support surfaces conforming to the recess so as to allow the cavity sub-assembly to be installed in the recess and removed from the recess by sliding rotation of the cavity sub-assembly relative to the shell member, the cavity sub-assembly being installed in the recess to a seating position exposing the molding surfaces where at least one stop surface of the cavity sub-assembly abuts a stop of the shell member, and releasable retaining means for restraining the cavity sub-assembly at the seating position whereby the cavity sub-assembly is retained in the shell member, the cavity sub-assembly, shell member and retaining means being effective to permit a cavity sub-assembly to be installed in and removed from a shell member while the shell member is retained in a clamp unit of a blow molding machine and the retaining means being adapted to restrain and release the cavity sub-assembly without use of tools.

2. The apparatus according to claim 1 wherein the stops of the shell member comprise separable stop plates attached to the shell member proximate the face thereof and projecting beyond the surface of the recess toward the centerline of the shell member.

3. The apparatus according to claim 1 wherein the retaining means comprises at least one pin member for engaging the cavity sub-assembly and the shell member to restrain the cavity sub-assembly at the seating position.

4. The apparatus according to claim 3 wherein the shell member and cavity sub-assembly comprise longitudinal grooves located so that with the cavity sub-assembly at the seating position the longitudinal grooves are aligned to define a pin receiving hole for receiving a pin member substantially filling the pin receiving hole whereby the cavity sub-assembly and shell member are engaged to restrain the cavity sub-assembly at the seating position and the pin member comprises a head end by which the pin member is inserted into and removed from the pin receiving hole.

5. The apparatus according to claim 4 wherein the stops of the shell member comprise separable stop plates attached to the shell member proximate the face thereof and projecting beyond the surface of the recess toward the centerline of the shell member.

6. The apparatus according to claim 4 wherein the pin member comprises a handle attached to a head end of the pin member to facilitate installation and removal of the pin member from the pin receiving hole.

7. The apparatus according to claim 6 wherein the pin receiving hole and pin member each comprise at least one longitudinal portion of reduced diameter and a shoulder separating the portions of different diameter such that with the pin member fully inserted into the pin receiving hole, the pin member shoulders abut the pin receiving hole shoulders.

8. The apparatus according to claim 7 wherein the stops of the shell member comprise separable stop plates attached to the shell member proximate the face thereof and projecting beyond the surface of the recess toward the centerline of the shell member.

9. The apparatus according to claim 3 wherein the shell member comprises at least one pin pocket into the recess for receiving a pin member and means for establishing the depth of the pin member in the pocket and the cavity sub-assembly comprises a pin recess for receiving a projection of the pin members beyond the recess, the depth establishing means effective to locate each pin member so that a portion thereof projects beyond the surface of the recess to engage the cavity sub-assembly while the pin member remains engaged with the shell member whereby the cavity sub-assembly is restrained at the seating position and effective to locate the pin members so that no portion thereof projects beyond the surface of the recess.

10. The apparatus according to claim 9 wherein the pin member comprises a piston and the means for establishing depth of the pin member within the pocket comprises passages for conducting pressurized fluid to act on the piston to establish the depth of the pin member in the pocket.

11. The apparatus according to claim 9 wherein the stops of the shell member comprise separable stop plates attached to the shell member proximate the face thereof and projecting beyond the surface of the recess toward the centerline of the shell member.

12. An apparatus for blow molding comprising first and second mating mold components, each mating mold component comprising a mold shell member having a recess open to a mating face of the mold component for receiving a cavity sub-assembly comprising at least one mold cavity member having molding surfaces and at least one support surface for support by the recess, the recess being substantially semi-cylindrical and the support surfaces conforming to the recess so as to allow the cavity sub-assembly to be installed in the recess and removed from the recess by sliding rotation of the cavity sub-assembly relative to the shell member, the cavity sub-assembly being installed in the recess to a seating position exposing the molding surfaces, and releasable retaining means for restraining the cavity sub-assembly at the seating position whereby the cavity sub-assembly is retained in the shell member, the cavity sub-assembly, shell member and retaining means being effective to permit a cavity sub-assembly to be installed in and removed from a shell member while the shell member is retained in a clamp unit of a blow molding machine and the retaining means being adapted to restrain and release the cavity sub-assembly without use of tools.

13. The apparatus according to claim 12 wherein the shell member comprises at least two pin pockets into the recess, each pin pocket receiving a pin member and means for establishing the depth of the pin members in the pockets and the cavity sub-assembly comprises pin recesses, each pin recess for receiving a projection of each pin member beyond the recess, the depth establishing means effective to locate two pin members within respective pockets so that a portion thereof projects into pin recesses while the pin members remain engaged with the shell member to restrain the cavity sub-assembly from sliding rotation at the seating position and effective to locate the pin members so that no portion thereof projects beyond the surface of the recess.

14. The apparatus according to claim 13 wherein the directions of travel of two pin members within the respective pockets therefore are oriented so that the cavity sub-assembly is restrained from sliding rotation by those two pin members when the pin members are advanced to engage the cavity sub-assembly while remaining engaged with the shell member.

15. The apparatus according to claim 14 wherein the pin members are located on a circumference of the recess.

16. The apparatus according to claim 13 wherein the cavity sub-assembly comprises a replaceable height insert, a particular height insert being selected according to the desired overall length of the molding surfaces and the pockets of all pin members are located in the portion of the recess so that when the pin members are advanced, the pin members all engage a cavity member the location of which as the cavity sub-assembly is installed in the recess is not altered by the particular height insert selected.

17. The apparatus according to claim 16 wherein the directions of travel of two pin members within the respective pockets therefore are oriented so that the cavity sub-assembly is restrained from sliding rotation by those two pin members when the pin members are advanced to engage the cavity sub-assembly while remaining engaged with the shell member.

18. The apparatus according to claim 17 wherein the pin members are located on a circumference of the recess.
